(19) United States
(12) Patent Application Publication
(10) Pub. No.: US 2012/0062817 A1
(43) Pub. Date: Mar. 15, 2012

(54) LIQUID CRYSTAL DISPLAY DEVICE

(75) Inventors: Yuuichi Kanbayashi, Osaka (JP); Tadashi Nemoto, Osaka (JP); Ryuzo Yuki, Osaka (JP); Hiroaki Shigeta, Osaka (JP); Naru Usukura, Osaka (JP); Hiromi Katoh, Osaka (JP)

(73) Assignee: SHARP KABUSHIKI KAISHA, Osaka (JP)

(21) Appl. No.: 13/322,137

(22) PCT Filed: Feb. 22, 2010
(86) PCT No.: PCT/JP2010/001153

§ 371 Date: Dec. 1, 2011

(30) Foreign Application Priority Data
May 26, 2009 (JP) 2009-126358

(51) Int. Cl. G02F 1/13357

(52) U.S. Cl. 349/61

(57) ABSTRACT

A liquid crystal display device 100 according to the present invention is provided with a liquid crystal panel 20 in which a liquid crystal layer 23 is disposed between an active matrix substrate 21 and an opposite substrate 22 and a backlight 10 that irradiates the liquid crystal panel 20 with light. The liquid crystal panel 20 has a plurality of optical sensor elements 30 that detect the intensity of received infrared light, and the backlight 10 has an infrared LED (light source) 12 that emits infrared light. On a device surface 100a, an infrared light transmissive sheet (infrared light partially transmissive portion) 50 that partially transmits infrared light is provided. The optical sensor elements 30 detect an input position from outside by detecting infrared light reflected from an inputting object such as a finger or the like placed on the device surface 100a. This way, an optical sensor integrated liquid crystal display device that can clearly distinguish whether or not an inputting object such as a finger or the like is touching the device surface can be achieved.

### TECHNICAL FIELD

The present invention relates to a liquid crystal display device that is provided with an optical sensor element inside a liquid crystal panel.

### BACKGROUND ART

Flat panel-type display devices, which are represented by liquid crystal display devices, have features such as being thin and light and low power consumption. Furthermore, technological development for improving display performance, such as colorization, higher resolution, and compatibility with moving images, has been progressing. Thus, flat panel-type display devices are incorporated today in a wide range of electronic devices, such as mobile phones, PDAs, DVD players, mobile game devices, laptop computers, computer monitors, televisions, and the like.

Against such a backdrop, in recent years, development of a liquid crystal display device in which an optical sensor element is respectively provided in each pixel (or any one of RGB pixels) in an image display region is in progress. For example, Patent Document 1 discloses a liquid crystal display device in which an optical sensor element formed of a photodiode is provided on a pixel region. As described, by incorporating an optical sensor element in each pixel, functions as an area sensor (specifically, scanning function, touch panel function, and the like) can be achieved in a conventional liquid crystal display device. Thus, the optical sensor element performs functions as an area sensor to achieve a display device having an integrated touch panel (or scanner).

As one example of such a display device having an integrated touch panel, Patent Document 1 discloses a liquid crystal display device that has a built-in infrared light sensor inside a liquid crystal panel and that detects an input position using this sensor. In this liquid crystal display device, if the light intensity of external light irradiated onto a display surface of the liquid crystal panel is higher than a prescribed value, infrared light that was not blocked by an instruction means such as a finger or the like is detected by the infrared light sensor. On the other hand, if the light intensity of external light is lower than the prescribed value, infrared light for detection is emitted from a backlight, and infrared light that is reflected by the instruction means is detected by the infrared light sensor.

### RELATED ART DOCUMENTS

### Patent Documents

Patent Document 1: Japanese Patent Application Laid-Open Publication “Japanese Patent Application Laid-Open Publication No. 2008-241807 (Published on Oct. 9, 2008)”

### SUMMARY OF THE INVENTION

### Problems to be Solved by the Invention

In the abovementioned liquid crystal display device having a touch panel function, the optical sensor element captures a pen or a finger displayed on a display panel as an image and detects the position of the tip of the pen or the fingertip to perform position detection.

When a touch panel input is performed with a finger or a pen to such a liquid crystal display device having a touch panel function, the amount of light the built-in optical sensor element in the liquid crystal display device receives does not change significantly whether or not the finger or the tip of the pen is in contact with the panel surface. Therefore, clearly distinguishing whether or not the finger or the input pen is touching the display panel is difficult.

Similarly, the problem of difficulty in distinguishing whether or not the display panel is touched can occur, for example, in a liquid crystal display device according to Patent Document 1 in which an input position is detected using an infrared light sensor.

The present invention seeks to address the aforementioned problems, and has an object to provide a liquid crystal display device equipped with a built-in optical sensor that can clearly distinguish whether or not a finger or an input pen is touching the panel surface.

### Means for Solving the Problems

In order to address the aforementioned problems, a liquid crystal display device according to the present invention is a liquid crystal display device that includes a liquid crystal panel in which a liquid crystal layer is disposed between an active matrix substrate and an opposite substrate and a backlight that irradiates the liquid crystal panel with light, wherein the liquid crystal panel includes a plurality of optical sensor elements that detect the intensity of received infrared light, wherein the backlight includes a light source that emits infrared light, wherein an infrared light partially transmissive portion that partially transmits infrared light is provided on an image display surface side of the liquid crystal panel, and wherein the optical sensor elements detect infrared light reflected from an inputting object on a surface of the device to detect an input position from outside.

According to the aforementioned configuration, an infrared light partially transmissive portion is provided on the image display surface side of the liquid crystal panel (thus, the surface of the liquid crystal display device). Therefore, a portion of infrared light emitted from the backlight and a portion of infrared light entering from the surface of the device (including infrared light reflected by an object) are shielded (absorbed) by the infrared light partially transmissive portion.

Here, when an inputting object, such as a finger, an input pen, or the like, is in contact with the device surface (i.e., during a touched state), infrared light that was partially transmitted from the infrared light partially transmissive portion and then reflected by the inputting object enters the optical sensor element at a ratio of approximately 100%. In contrast, when the inputting object, such as a finger, an input pen, or the like, is not in contact with the device surface (i.e., during an untouched state), a portion of infrared light that was reflected by the inputting object is absorbed in the infrared light partially transmissive portion, thereby reducing reflected light entering the optical sensor element.

This way, compared to a case in which the infrared light partially transmissive portion is not provided, the difference in values detected by the optical sensor element between a touched state and an untouched state can be increased further. As a result, compared to a conventional liquid crystal display device, whether or not the inputting object, such as a finger, an input pen, or the like, is touching the device surface can be distinguished with more ease.

### Effects of the Invention

In a liquid crystal display device according to the present invention, the liquid crystal panel includes a plurality of optical sensor elements that detect the intensity of received infrared light, and the backlight includes a light source that emits infrared light. On the image display surface side of the liquid crystal panel, an infrared light partially transmissive portion that partially transmits infrared light is provided. The optical sensor elements detect an input position from outside by detecting infrared light reflected from an inputting object on a surface of the device.

According to the present invention, whether or not an inputting object, such as a finger, an input pen, or the like, is touching the device surface can be clearly distinguished.

### BRIEF DESCRIPTION OF THE DRAWINGS

FIG. 1 is a cross-sectional view showing a configuration of a liquid crystal display device according to an embodiment of the present invention.

FIG. 2 is a plan view showing a configuration of an infrared light transmissive sheet equipped in the liquid crystal display device shown in FIG. 1.

FIG. 3 is a cross-sectional view showing a configuration of the infrared light transmissive sheet equipped in the liquid crystal display device shown in FIG. 1.

FIG. 4 is a drawing schematically showing the paths of infrared light when a finger is touching the liquid crystal display device shown in FIG. 1 and when a finger is not touching the liquid crystal display device shown in FIG. 1.

FIG. 5(a) is a schematic view showing a state of signal light when a finger is touching a liquid crystal display device of the present invention and when a finger is not touching the liquid crystal display device of the present invention. FIG. 5(b) is a schematic view showing a state of signal light when a finger is touching a conventional liquid crystal display device and when a finger is not touching the conventional liquid crystal display device.

FIG. 6(a) is a schematic view showing a gray scale value of the optical sensor when a finger is touching the liquid crystal display device of the present invention and when a finger is not touching the liquid crystal display device of the present invention. FIG. 6(b) is a schematic view showing a gray scale value of the optical sensor when a finger is touching a conventional liquid crystal display device and when a finger is not touching the conventional liquid crystal display device.

FIG. 7(a) is a drawing schematically showing reflected light when a surface of a finger touching the device covers a plurality of infrared light transmissive regions of the infrared light transmissive sheet. FIG. 7(b) is a drawing schematically showing an image of received light by the optical sensor element when the infrared light transmissive region of the infrared light transmissive sheet is in a circular shape.

FIG. 8 is a graph showing a relation between a sensor position and a sensor gray scale value when the infrared light transmissive region of the infrared light transmissive sheet is in a circular shape.

FIG. 9 is a graph showing a relation between the distance of a finger from the device surface and a sensor value in a conventional liquid crystal display device.

### DETAILED DESCRIPTION OF EMBODIMENTS

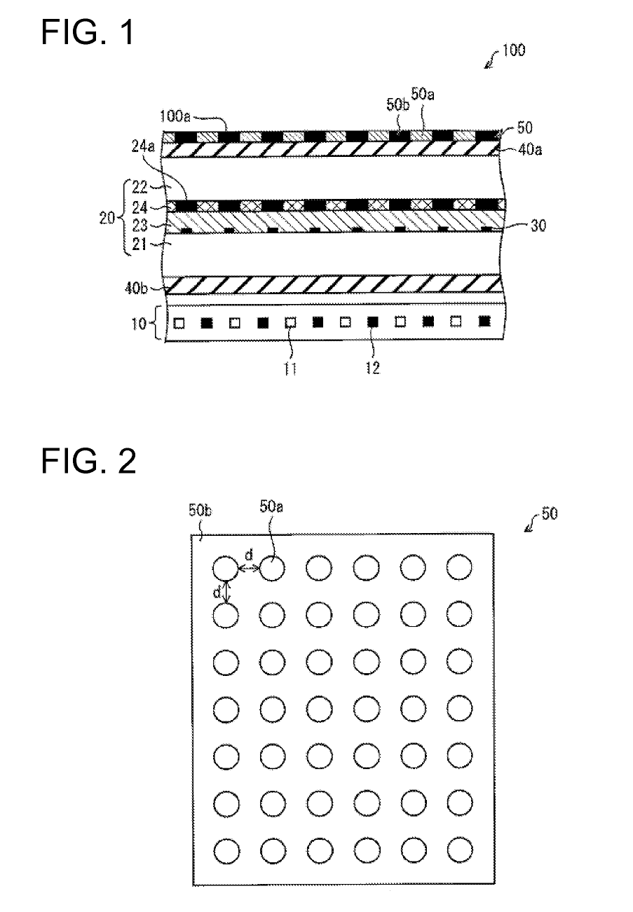

Embodiments of the present invention are described below with reference to FIGS. 1 to 9. The present invention is not limited thereto.

In an embodiment of the present invention, a liquid crystal display device having a touch panel function in which a touched position can be detected when an inputting object such as a finger or the like touches the surface of the device is described.

First, a configuration of a touch panel integrated liquid crystal display device according to the present embodiment is described with reference to FIG. 1. A touch panel integrated liquid crystal display device 100 (also referred to as a “liquid crystal display device 100”) shown in FIG. 1 has a touch panel function in which an optical sensor element provided in each pixel detects an image on a surface of a display panel to detect an input position.

As shown in FIG. 1, the touch panel integrated liquid crystal display device 100 according to the present embodiment is provided with a liquid crystal panel 20 and a backlight 10 that is disposed on the back side of the liquid crystal panel and that irradiates the liquid crystal panel with light.

The backlight 10 is provided with two types of light sources, which are white LEDs 11 that emit white light and infrared LEDs 12 (a light source emitting infrared light) that emit infrared light. The white LED has been conventionally used as a typical light source to display an image. On the other hand, the infrared LED is for detecting an input position of an inputting object such as a finger or the like by an optical sensor element 30. Therefore, in the liquid crystal display device 100, infrared light irradiated by the infrared LED is reflected by a surface of an inputting object. The optical sensor element 30 senses this reflected light to detect the input position.

In the present embodiment, the white LED and the infrared LED, which are separate light sources that emit light having different wavelength regions, are used as light sources used in the backlight 10. However, the present invention is not limited thereto, and only one type of LED that can generate light having wavelength regions ranging from visible light to infrared light may be used.

The liquid crystal panel 20 has a configuration in which an active matrix substrate 21 having a number of pixels arranged in a matrix and an opposite substrate 22 that is disposed to face the active matrix substrate 21 are provided in addition to a liquid crystal layer 23, which is a display medium, interposed between these two substrates.

On the outer side of the active matrix substrate 21 and the opposite substrate 22, a front side polarizing plate 40a and a back side polarizing plate 40b are provided respectively.

The respective polarizing plates 40a and 40b play a role of polarizers. For example, if liquid crystal material encapsulated in the liquid crystal layer is a vertically oriented type, the polarizing direction of the front side polarizing plate 40a and the polarizing direction of the back side polarizing plate 40b are arranged such that they are in a relation of a crossed Nicols state to each other. This way, a liquid crystal display device of normally black mode can be achieved.

Although not shown in the figure, a front side retardation plate and a back side retardation plate may be provided between the opposite substrate 22 and the front side polarizing plate 40a and between the active matrix substrate 21 and the back side polarizing plate 40b, respectively, as optical compensation elements. The front side retardation plate and the back side retardation plate are disposed in order to improve the transmittance as well as viewing angle characteristics when, for example, a liquid crystal material encapsulated in the liquid crystal layer is a vertically oriented type. However, display can be performed even with a configuration in which these retardation plates are not provided.

On the front side polarizing plate 40a, an infrared light transmissive sheet 50 (infrared light partially transmissive portion) that partially transmits infrared light is provided. In the liquid crystal display device 100, the infrared light transmissive sheet 50 is disposed on the outermost surface of the device to form a device surface 100a. The infrared light transmissive sheet 50 includes an infrared light transmissive region 50a that transmits infrared light and an infrared light blocking region (non-transmissive region) 50b that blocks infrared light, and can transmit or block infrared light in respective regions. The liquid crystal display device 100 of the present embodiment can clearly distinguish whether or not an inputting object such as a finger or the like is touching the device surface 100a by having this infrared light transmissive sheet 50 disposed on the outermost surface of the device.

The active matrix substrate 21 is provided with TFTs, which are switching elements for driving the respective pixels, an alignment film (not shown in the figure), the optical sensor element 30, and the like.

On the opposite substrate 22, a color filter layer 24, an opposite electrode, an alignment film (both not shown in the figure), and the like are formed. The color filter layer 24 is constituted of a colored portion having the respective colors of red (R), green (G), and blue (B), a black matrix, and a visible light cut filter 24a that blocks visible light out of light entering the optical sensor element 30 from the device surface (detection object surface) 100a and selectively transmits light in an infrared region.

As a configuration of the visible light cut filter 24a, a multilayer configuration of color filters in two colors out of the aforementioned three colors that constitute the color filter, or a mixture of a red pigment, a green pigment, and a blue pigment can be suggested, for example. More specifically, a configuration of a visible light cut filter according to Patent Document 1 can be applied. According to such a configuration, the visible light cut filter 24a can block light in a visible region out of light entering from the detection object surface 100a and selectively transmit light in an infrared region to the optical sensor element 30 side.

The configuration of the visible light cut filter 24a is not limited to the aforementioned configuration. Furthermore, in the present invention, a configuration in which the optical sensor element 30 can selectively sense infrared light is sufficient. Therefore, the present invention is not limited to a configuration in which the visible light cut filter 24a is incorporated in the color filter layer 24. However, if the visible light cut filter 24a is formed using colored pigments that are materials of the color filter, the visible light cut filter 24a can be incorporated in the color filter layer 24, thereby simplifying the manufacturing steps.

The visible light cut filter in the present invention is disposed over the optical sensor element 30 (between the detection object surface 100a and the respective optical sensor elements 30), and is sufficient if it transmits more light in the infrared region than light in regions other than the infrared region.

Because the visible light cut filter 24a is disposed over the optical sensor element 30, infrared light primarily enters a light receiving portion of the optical sensor element 30. Thus, the optical sensor element 30 can perform an output corresponding to the intensity of infrared light.

As described above, the touch panel integrated liquid crystal display device 100 of the present embodiment has the optical sensor element 30 disposed in each pixel region to form an area sensor. When a finger touches a specific position on a surface of the liquid crystal display device 100 (detection object surface 100a), the optical sensor element 30 can read its position, input information into the device, and execute an intended operation. This way, according to the liquid crystal display device 100 of the present embodiment, the touch panel function can be achieved by the optical sensor element 30.

The optical sensor element 30 is formed of a photodiode or a phototransistor, and detects the amount of light received by applying an electric current corresponding to the intensity of received light. The TFT and the optical sensor element 30 may be monolithically formed by substantially the same process on the active matrix substrate 21. Thus, a component of a portion of the optical sensor element 30 may be formed at the same time as a component of a portion of the TFT. A forming method of such an optical sensor element can be performed according to a publicly known manufacturing method of a liquid crystal display device having a built-in optical sensor element.

According to the present invention, the optical sensor element may not necessarily be provided in each pixel. For example, a configuration in which an optical sensor is provided in the respective pixels having a color filter in any one of colors R, G, and B may be used.

The liquid crystal display device 100 of the present embodiment has a light source that emits infrared light in the backlight 10. In addition, over the respective optical sensor elements 30, the visible light cut filter 24a that blocks visible light and that selectively transmits infrared light is provided. According to this configuration, in the liquid crystal display device 100, when a finger touches the device surface 100a, infrared light that was irradiated from the backlight 10 is reflected by the finger touching the device surface 100a, and the optical sensor elements 30 can detect this reflected light.

Therefore, according to the liquid crystal display device 100 of the present embodiment, position detection can be performed with a high degree of accuracy without causing changes in output of the sensor due to the brightness of an image displayed on the liquid crystal panel 20 when the device is in a relatively dark environment, for example.

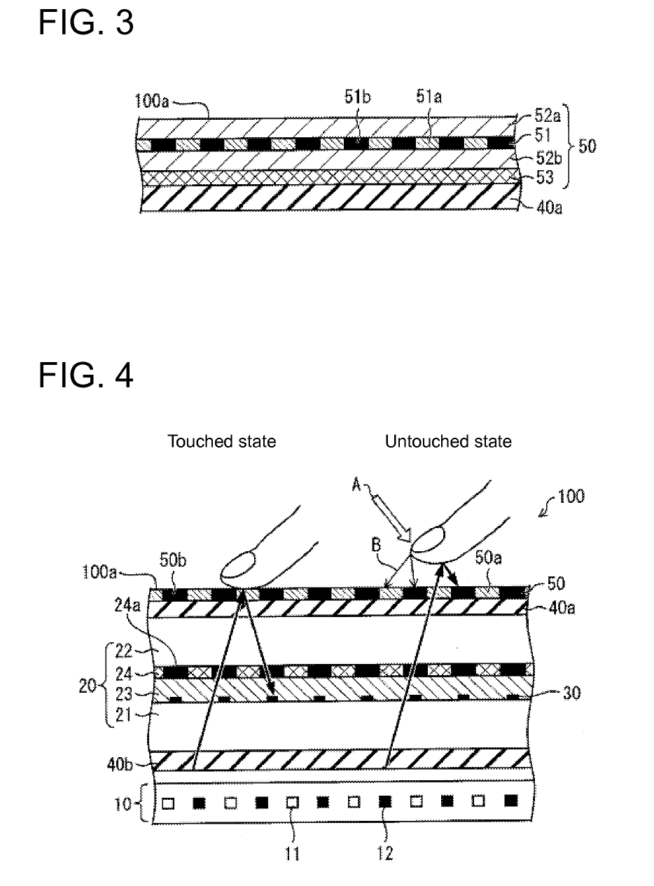

Next, a more specific configuration of the infrared light transmissive sheet 50 provided in the liquid crystal display device 100 is described. FIG. 2 shows a planar configuration of the infrared light transmissive sheet 50. FIG. 3 shows a cross-sectional configuration of the infrared light transmissive sheet 50. Here, the cross-sectional view of FIG. 3 also shows the front side polarizing plate 40a.

As shown in FIG. 2, the infrared light transmissive sheet 50 is provided with a plurality of circular-shaped infrared light transmissive regions 50a, and the respective infrared light transmissive regions 50a are arranged regularly in vertical and horizontal directions. The region of the infrared light transmissive sheet 50 excluding the infrared light transmissive regions 50a is the infrared light blocking region (non-transmissive region) 50b that does not transmit infrared light.

Furthermore, as shown in FIG. 3, the infrared light transmissive sheet 50 has a configuration in which a protective layer 52a, an infrared light partially transmissive layer 51 (infrared light partially transmissive portion), a protective layer 52b, and an adhesive layer 53 are laminated in this order from the device surface 100a side. In other words, the infrared light transmissive sheet 50 has the infrared light partially transmissive layer 51 interposed between the two protective layers 52a and 52b, and is attached to the front side polarizing plate 40a by the adhesive layer 53 disposed below the protective layer 52b.

In the infrared light partially transmissive layer 51, a portion corresponding to the infrared light transmissive region 50a is a cavity portion 51a, and a portion corresponding to the non-transmissive region 50b is formed of a band-pass filter (BPF) 51b that blocks light in the infrared region. The protective layers 52a and 52b are formed of a transparent material such as polyethylene terephthalate (PET) or the like. The adhesive layer 53 is formed of an acrylic resin or the like.

As a base material of the protective layers (protective films), other than the aforementioned PET, various types of synthetic resin films having flexibility and transparency such as polyethylene or the like may be used. Among these, the aforementioned PET has superior transparency compared to polyethylene. Therefore, an optical member such as a polarizing plate or the like can be tested even if a protective layer formed of PET is attached thereon. Thus, the protective layers 52a and 52b are preferably formed of polyethylene terephthalate (PET).

The infrared light transmissive sheet 50 having the aforementioned configuration can be manufactured by the following method, for example.

First, an inorganic multilayer film is deposited on the overall surface of a sheet-shaped member that becomes a material for the infrared light partially transmissive layer 51 by vapor deposition to form the band-pass filter 51b, which blocks infrared light. Then, a circular shape is punched into the band-pass filter 51b at a prescribed location to form the cavity portion 51a corresponding to the infrared light transmissive region 50a. On both surfaces of the infrared light partially transmissive layer 51 obtained this way, protective sheets are attached to form the protective layers 52a and 52b. Then, a material of the adhesive layer 53 is applied on the surface of the protective layer 52b, and is attached to the front side polarizing plate 40a to obtain the infrared light transmissive sheet 50.

The surface of the protective layer 52a constituting the device surface 100a may be subjected to a diffusion treatment such as an AG treatment, an AR treatment, or the like.

The thickness of the infrared light partially transmissive layer 51 and the protective layers 52a and 52b, which constitute the infrared light transmissive sheet 50, is approximately 30 μm, respectively, and the sum of the thicknesses of the three layers is approximately 90 μm. However, this is one example, and the present invention is not limited to such. Taking into account the total thickness of the device 100, the thickness of the infrared light transmissive sheet 50 (the sum of the thickness of the infrared light partially transmissive portion and the two protective layers) is preferably 200 μm or less. Also, the thickness of the infrared light transmissive sheet 50 is preferably 30 μm or more because in-plane unevenness tends to occur due to a contraction caused by heat if the sheet is made too thin.

The infrared light transmissive region 50a and the non-transmissive region 50b of the infrared light transmissive sheet 50 have mutually different light transmittances. Therefore, if the respective infrared light transmissive regions 50a are made too large, their boundaries become visible. Furthermore, if the respective infrared light transmissive regions 50a are made too small, the overall sensor output decreases, and a sufficient sensor output cannot be obtained when a finger touches the device surface. Thus, the dimension of the respective infrared light transmissive regions 50a is preferably within a range of 5 to 30 μm (5 μm or more and 30 μm or less). Here, the dimension of the infrared light transmissive region 50a means the dimension of the widest portion of this region, and if the infrared light transmissive region 50a is in a circular shape, it means the diameter of the circle.

As another method for making the boundaries between the infrared light transmissive region 50a and the non-transmissive region 50b less visible, a method in which a diffusion treatment is performed on the adhesive layer 53 can be suggested. Here, as the diffusion treatment performed on the adhesive layer 53, a treatment in which fine particles (diffusers) formed of Si (silica) or the like are mixed in the adhesive layer 53 can be suggested, for example.

Of the respective infrared light transmissive regions 50a, which are arranged regularly, an interval “d” (see FIG. 2) between the respective infrared light transmissive regions 50a and 50a that are adjacent to each other preferably is 10 to 200 μm. By making the interval d 10 μm or more, a prescribed shape (specifically, a circular shape) of the infrared light transmissive region 50a can be reflected in a sensing image, which is detected by the optical sensor element 30. This way, the optical sensor element 30 can distinguish reflected light from an inputting object such as a finger or the like from other light with ease. On the other hand, if the interval d is made too large, the absolute intensity of reflected light (this is referred to as “signal light”) from an inputting object such as a finger or the like decreases, making it more difficult for the optical sensor element 30 to detect signal light. Thus, by making the interval d 200 μm or less, significant decrease in the intensity of signal light can be suppressed, and the optical sensor element 30 can detect the signal light with ease.

The aforementioned configuration of the infrared light transmissive sheet 50 is one example, and the present invention is not limited to such a configuration. Thus, the shape of the infrared light transmissive region 50a does not necessarily need to be a circular shape. However, if the respective infrared light transmissive regions 50a are all in the same shape, the optical sensor element 30 can recognize this specific shape as a sensing image when an inputting object such as a finger or the like touches the device surface 100a. This way, the input position can be detected more accurately.

Furthermore, the respective infrared light transmissive regions 50a do not necessarily need to be arranged regularly as long as they are arranged with a certain level of density or higher per unit area.

Furthermore, in the aforementioned infrared light transmissive sheet 50, the infrared light transmissive region 50a is formed of the cavity portion 51a. However, in the present invention, the infrared light transmissive region 50a and the non-transmissive region 50b may be formed by patterning and depositing a multilayer inorganic film by vapor deposition on the surface of the front side polarizing plate 40a to form the infrared light transmissive sheet 50.

The liquid crystal display device 100 of the present embodiment can distinguish whether or not an inputting object such as a finger or the like is touching the device surface 100a with ease by having the infrared light transmissive sheet 50, which has the aforementioned configuration, provided on the outermost surface of the device. This point is described below.

Here, how a conventional liquid crystal display device having a built-in optical sensor that uses infrared light distinguishes between a touched state and an untouched state is described.

A touch panel integrated liquid crystal display device needs to distinguish between a touched state and an untouched state based on an image obtained by the respective optical sensor elements provided in the liquid crystal panel such that a contact to a device surface by a finger in the weight of 30 g or less can be recognized as the touched state and such that a state in which the finger is away from the device surface by approximately 1 mm can be recognized as the untouched state, for example.

However, in the conventional liquid crystal display device having a built-in optical sensor, the difference in the intensity of reflected light (signal light) from a finger, which is detected by the optical sensor element, is small between when the finger is touching the device surface and when the finger is approximately 1mm away from the device surface. As a result, an error in distinguishing between the touched stated and the untouched state occurs.

FIG. 9 shows a normalized example of optical sensor values when a finger moves away from the surface of the conventional liquid crystal display device.

FIG. 9 shows sensor values when two testers (tester A and tester B) change the distance of their fingers from the device surface. Here, the distance of 0 mm means that their fingers are touching the device surface.

Furthermore, in FIG. 9, the solid line represents simulation results of the relation between the distance from the device surface and the sensor values when the shape of the pad portion of a finger (surface of the fingertip) is assumed to be in a planar shape. The dashed line represents simulation results of the relation between the distance from the device surface and the sensor values when the shape of the pad portion of the finger is assumed to be in a columnar shape.

As shown in FIG. 9, it can be said that the relation between the distance and the sensor values varies depending on the respective individuals or the shape of their fingers. Especially, in the case of the tester B and when the finger is in a planar shape, it can be said that distinguishing between a touched state and an untouched state is difficult because the sensor value remains high even when the distance from the device surface increases.

In a conventional liquid crystal display device having a typical built-in touch panel, the required difference in sensor values for distinguishing between a touched state and an untouched state is 10/256 gray scale or higher. In contrast, in the case of the tester A, the sensor value at the distance of 0 mm is 220/256 gray scale (actual measured value), and the sensor value at the distance of 1 mm is 211/256 gray scale (actual measured value). Therefore, their difference is 9/256 gray scale, and it can be said that distinguishing between a touched state and an untouched state is difficult.

In contrast, because the liquid crystal display device 100 of the present embodiment is provided with the infrared light transmissive sheet 50, it makes the difference in the intensity of signal light (thus, values detected by the optical sensor element) between a touched state and an untouched state larger.

In other words, because infrared light from the backlight transmitted through the infrared light transmissive sheet 50 is reflected by the surface of a finger touching the device surface 100a when the finger touches the device surface 100a, the intensity of the signal light detected by the optical sensor element 30 is retained relatively high (see the figure on the left side in FIG. 4).

On the other hand, when the finger is not touching the device surface 100a, infrared light from the backlight transmitted through the infrared light transmissive sheet 50 is first reflected by the finger. Then, a portion of the infrared light is blocked by the non-transmissive region 50b of the infrared light transmissive sheet 50. Therefore, the signal light detected by the optical sensor element 30 is reduced further (see the figure on the right side in FIG. 4). As a result, the difference in sensor value between a touched state and an untouched state can be increased further.

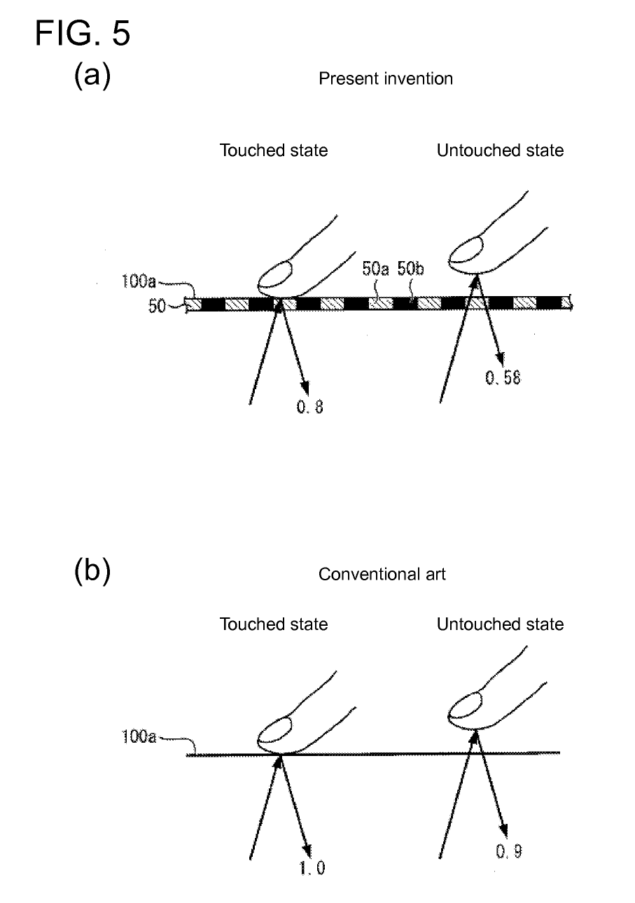

A case in which the aperture ratio of the infrared light transmissive sheet 50 is 80% (the ratio of the infrared light transmissive region 50a to the entire region is 80%), for example, is described. FIG. 5 comparatively shows the intensities of signal light in a touched state and an untouched state in the liquid crystal display device 100 having this infrared light transmissive sheet 50 and in a conventional liquid crystal display device. The respective numerical values shown in FIG. 5 comparatively show the intensities of signal light in the respective cases shown in the figure.

As shown in FIG. 5(b), suppose that the intensity of signal light during a touched state is 1.0 in the conventional liquid crystal display device. Then, as shown in FIG. 5(a), the intensity of signal light during a touched state is 0.8 in the liquid crystal display device 100. Moreover, as shown in FIG. 5(b), the intensity of signal light during a touched state becomes 0.9 in the conventional liquid crystal display device. In contrast, the intensity of signal light during an untouched state in the liquid crystal display device 100 becomes 0.9×0.8×0.8=0.58 (see FIG. 5(a)) because it is transmitted through the infrared light transmissive sheet 50 twice. This way, in the liquid crystal display device 100, the intensity itself of signal light during a touched state is lower than that of the conventional liquid crystal display device. However, the difference in signals between a touched state and an untouched state becomes larger.

As described above, in the liquid crystal display device 100 of the present embodiment, infrared light that is transmitted through the infrared light transmissive region 50a of the infrared light transmissive sheet 50 and that reflects the finger enters the optical sensor element 30 during a touched state at the ratio of approximately 100%. In contrast, during an untouched state, a portion of infrared light reflecting the finger is absorbed by the non-transmissive region 50b of the infrared light transmissive sheet 50, thereby reducing reflected light that enters the optical sensor element 30. This way, the difference in detected values by the optical sensor element between a touched state and an untouched state can be increased. Thus, a touched state and an untouched state can be distinguished with more ease compared to the conventional liquid crystal display device.

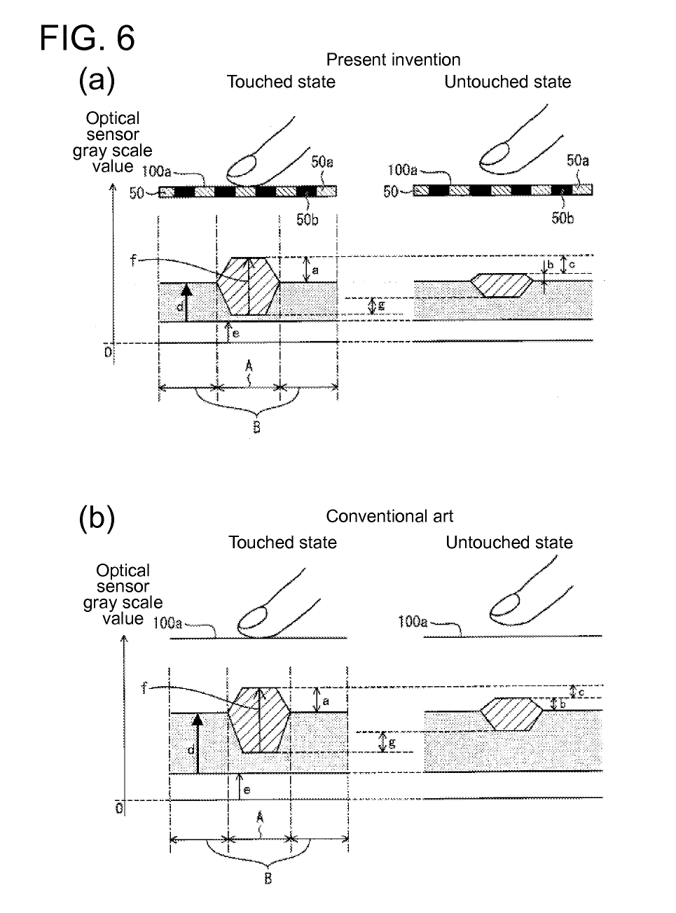

FIG. 6(a) schematically shows optical sensor gray scale values that are detected in a region surrounding a finger when the finger is touching the liquid crystal display device and when it is not touching the liquid crystal display device. For comparison, FIG. 6(b) schematically shows optical sensor gray scale values that are detected in a region surrounding a finger when the finger is touching a conventional liquid crystal display device and when it is not touching the conventional liquid crystal display device.

As shown in FIG. 6(a) and FIG. 6(b), in both the liquid crystal display device 100 of the present embodiment and the conventional liquid crystal display device, there is light that is detected by the optical sensor element regardless of the actual input position. Such light is called “noise light” because it causes recognition errors of an input position on a touch panel.

Noise light includes light that is irradiated from a backlight and that is detected by being reflected inside the device (noise represented by “e” in FIG. 6(a) and FIG. 6(b)) and light that is detected due to external light entering from the periphery of the device (noise represented by “d” in FIG. 6(a) and FIG. 6(b)), and the like, for example. Here, as shown in FIG. 6(a) and FIG. 6(b), in both the present invention and the conventional liquid crystal display device, there is a difference in the amount of diffracted external light at a touched portion between a touched state and an untouched state. This difference is “g.” The value “f,” which is obtained by subtracting the aforementioned amounts of change in gray scale values “e” and “d” of the noise light from an optical sensor gray scale value detected at the touched portion, is the amount of change in optical sensor gray scale value caused by the signal light.

Furthermore, in FIG. 6(a) and FIG. 6(b), the difference in optical sensor gray scale value between a touched portion A and the other portion (surrounding area B) during a touched state is represented by “a,” and the difference in optical sensor gray scale value between a touched portion and the other portion (surrounding area) during an untouched state is represented by “b.” The difference in optical sensor gray scale value between a touched state and an untouched state is represented by “c.”

In a touch panel integrated liquid crystal display device, in order to detect an input position well, the aforementioned difference “a” in optical sensor gray scale value preferably is 20/256 gray scale value or higher, and the aforementioned difference “b” in optical sensor gray scale value preferably is lower than 10/256 gray scale value. Furthermore, the aforementioned difference “c” in optical sensor gray scale value preferably is 10/256 gray scale value or higher.

As a comparison between FIG. 6(a) and FIG. 6(b) shows, in the liquid crystal display device 100 of the present embodiment, the optical sensor gray scale values are reduced overall compared to the conventional liquid crystal display device. However, by further lowering the aforementioned difference “b” in optical sensor gray scale value, the aforementioned difference “c” in optical sensor gray scale value can be increased further.

Furthermore, conventionally, if the IR intensity of surrounding external light becomes 3000 mW/m² (corresponds to 300 lux (1×) in an incandescent lamp) or more, the sensor value of surrounding external light becomes higher, and the difference between signal light and noise light becomes small, resulting in a recognition error. However, according to the liquid crystal display device 100 of the present embodiment, noise light can be reduced by the infrared light transmissive sheet. Therefore, it can be used under higher illuminance than the conventional device.

Furthermore, in the conventional liquid crystal display device, reflected light (the fingertip beams B) from external light A is generated at a fingertip, which caused recognition errors of the touch panel. In the liquid crystal display device 100 of the present embodiment, the intensity of this fingertip beam can be also reduced by the non-transmissive region 50b of the infrared light transmissive sheet 50 (see the figure on the right side in FIG. 4).

Moreover, in the case of an untouched state, a signal of an untouched state was relatively high because of the presence of a component of diffracted external light. However, the external light component can be also removed by the infrared light transmissive sheet 50. Thus, the difference in signal intensity between a touched state and an untouched state can be increased further.

Furthermore, in the infrared light transmissive sheet 50, by making the shape of all of the respective infrared light transmissive regions 50a into a prescribed uniform shape, an image (signal shape), which is recognized by the optical sensor element when a finger or the like touches the device surface, can be expected to become a signal shape corresponding to the shape of the infrared light transmissive region 50a. For example, if the infrared light transmissive region 50a is in a circular shape, the signal shape also becomes a blurry circular shape.

If infrared light resulting from external light is transmitted through the infrared light transmissive sheet 50 of the present embodiment, basically, the shape (for example, a circular shape) of the infrared light transmissive region 50a is recognized, as is, as an image by the optical sensor element 30. However, when the interval between the respective infrared light transmissive regions is too narrow, for example, there is a possibility that transmitted light overlap with each other (blurred circular shape and the like). In such a case, a correction can be performed by calibrating the optical sensor element so that detection of noise light resulting from external light by the optical sensor element can be avoided.

As described above, if a distinguishing feature can be given to the signal shape when a finger or the like touches the device surface, distinguishing infrared light resulting from external light from infrared light reflected by a pad of a finger becomes possible. Thus, recognition can be performed with ease even under the environment such as outdoor and the like where the amount of infrared light included in external light is high.

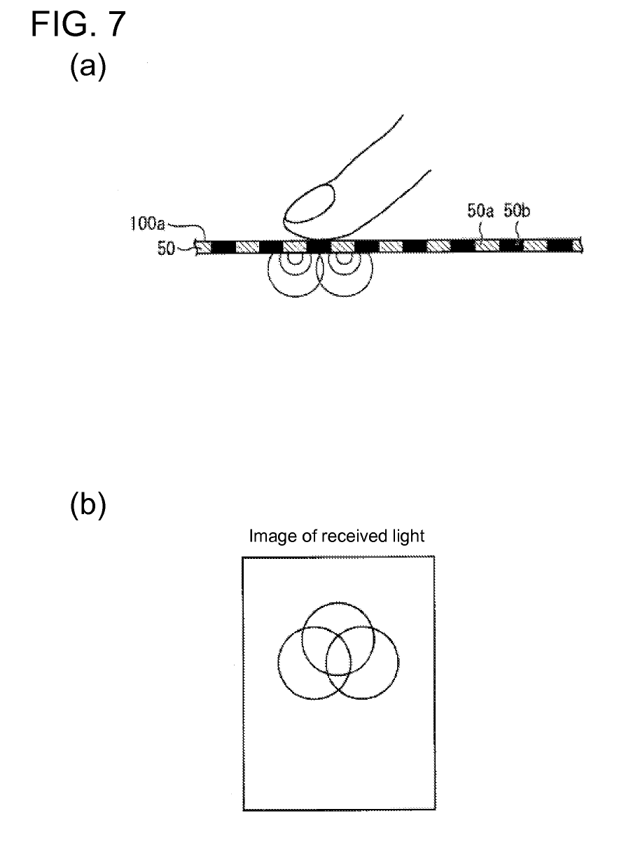

Particularly, as shown in FIG. 7(a), if a finger touching the device surface 100a covers a plurality of infrared light transmissive regions 50a of the infrared light transmissive sheet 50, a portion that overlaps the reflected signal light is formed. As a result, the optical sensor element 30 can detect signal light that has a distinctive shape. For example, if the shape of the respective infrared light transmissive regions 50a is in a circular shape, signal light is recognized as a shape in which a plurality of circles overlap one another by the optical sensor element 30 at the portion touched by the finger as shown in FIG. 7(b). This way, noise light resulting from external light and signal light can be distinguished with more ease.

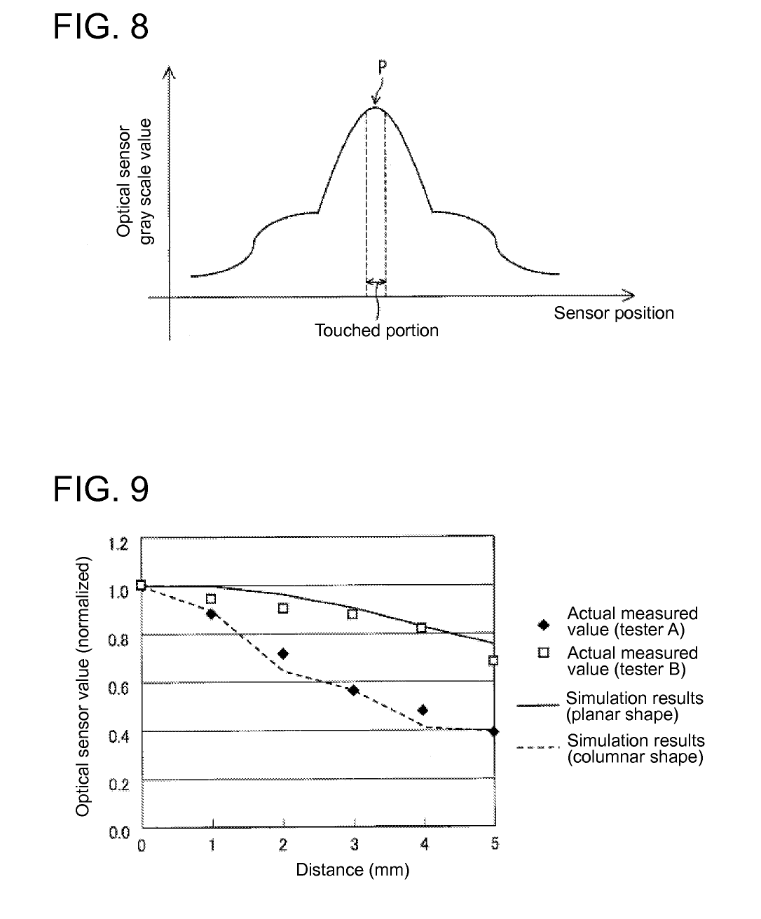

FIG. 8 shows the relation between a sensor position and sensor gray scale values when the infrared light transmissive region of the infrared light transmissive sheet is in a circular shape. Here, the peak “P” of the optical sensor gray scale values in this figure corresponds to a portion touched by a finger through the infrared light transmissive region 50a.

If the infrared light transmissive region is in a circular shape, when a finger touches the device surface, a mountain-like shape shown in the graph of FIG. 8 is detected by the optical sensor. On the other hand, when noise light such as infrared light contained in external light or the like is transmitted through the infrared light transmissive sheet having circular infrared light transmissive regions, the circular shape of the sheet is recognized, as is, as an image by the optical sensor element.

The optical sensor element recognizes such a difference in shape to distinguish between noise light and signal light with more ease.

As described above, by having the infrared light transmissive sheet 50, which partially transmits infrared light, the liquid crystal display device 100 of the present embodiment can increase the difference in detected value by the optical sensor element between a touched state and an untouched state compared to a liquid crystal display device in which the aforementioned sheet 50 is not provided. Thus, compared to the conventional liquid crystal display device, when the device surface is touched by an inputting object, such as a finger, a pen, or the like, and when the device surface is not touched can be distinguished with more ease.

The liquid crystal display device of the present invention is a liquid crystal display device that includes a liquid crystal panel in which a liquid crystal layer is disposed between an active matrix substrate and an opposite substrate and a backlight that irradiates the liquid crystal panel with light. The liquid crystal panel includes a plurality of optical sensor elements that detect the intensity of received infrared light. The backlight has a light source that emits infrared light. An infrared light partially transmissive portion that partially transmits infrared light is provided on an image display surface side of the liquid crystal panel, and the optical sensor elements detect an input position from outside by detecting infrared light reflected from an inputting object on a surface of the device.

According to the aforementioned configuration, by providing the infrared light partially transmissive portion on the image display surface side of the aforementioned liquid crystal panel (i.e., the surface of the liquid crystal display device), a portion of infrared light emitted from the backlight and a portion of infrared light entering from the surface of the device (including infrared light reflected by an object) are shielded (absorbed) by the infrared light partially transmissive portion.

When an inputting object, such as a finger, an input pen, or the like, is in contact with the device surface (i.e., touched state), infrared light that was partially transmitted from the infrared light partially transmissive portion is reflected by the inputting object, and then enters the optical sensor element at the ratio of approximately 100%. On the other hand, when the inputting object, such as a finger, an input pen, or the like, is not in contact with the device surface (i.e., untouched state), a portion of infrared light that was reflected by the inputting object is absorbed by the infrared light partially transmissive portion, and reflected light entering the optical sensor element is reduced.

As a result, compared to the case in which the infrared light partially transmissive portion is not provided, the difference in detected value by the optical sensor element between a touched state and an untouched state can be increased further. Therefore, compared to the conventional liquid crystal display devices, when the device surface is touched by an inputting object, such as a finger, an input pen, or the like, and when the device surface is not touched can be distinguished with more ease.

In the liquid crystal display device of the present invention, the infrared light partially transmissive portion may include a non-transmissive region that does not transmit infrared light and a plurality of infrared light transmissive regions that are arranged regularly with respect to the non-transmissive region.

According to the aforementioned configuration, by having the infrared light transmissive regions regularly arranged with respect to the non-transmissive region, a constant sensor output can be obtained regardless of at which position an inputting object such as a finger or the like is placed at on the device surface.

In the liquid crystal display device of the present invention, the dimension of the aforementioned respective infrared light transmissive regions may be 5 μm or more and 30 μm or less.

According to the aforementioned configuration, by making the dimension of the aforementioned region 5 μm or more, a sufficient sensor output for detecting an input position can be obtained. Moreover, by making the aforementioned region 30 μm or less, the boundaries between the infrared light transmissive regions and the non-transmissive region becoming visible can be prevented.

In the liquid crystal display device of the present invention, the aforementioned respective infrared light transmissive regions may have the same shape.

According to the aforementioned configuration, when an inputting object such as a finger or the like touches the device surface, the optical sensor element recognizes the specific shape of the respective infrared light transmissive regions as a sensing image. This way, the optical sensor element can distinguish and recognize between infrared light included in external light and light resulting from the backlight reflected by the finger with ease. Thus, the input position can be detected more accurately.

In the liquid crystal display device of the present invention, the aforementioned respective infrared light transmissive region may have a circular shape.

According to the aforementioned configuration, the reflected light at a portion touched by a finger becomes a circular shape. When light enters a circular-shaped transmissive region (opening region), its diffracted light spreads concentrically. Therefore, by making the infrared light transmissive region a circular shape, unevenness in the intensity and distributions of light can be controlled with ease.

In the liquid crystal display device of the present invention, an interval between the respective infrared light transmissive regions adjacent to each other may be 10 μm or more and 200 μm or less.

According to the aforementioned configuration, by making the interval between the respective infrared light transmissive regions adjacent to each other 10 μm or more, the shape (for example, a circular shape) of the infrared light transmissive region can be reflected in a sensing image detected by the optical sensor element. Furthermore, by making the interval between the respective infrared light transmissive regions adjacent to each other 200 μm or less, lowering of the intensity of signal light can be suppressed, and the optical sensor element can detect signal light with ease.

In the liquid crystal display device of the present invention, the aforementioned non-transmissive region may be formed of a band-pass filter that blocks light in an infrared region, and the aforementioned infrared light transmissive region may be formed of a cavity.

In the aforementioned configuration, the infrared light transmissive region can be formed by punching a prescribed shape out of the band-pass filter. Therefore, the infrared light partially transmissive portion can be formed in a simple manufacturing process.

In the liquid crystal display device of the present invention, the aforementioned infrared light partially transmissive portion may be disposed so as to be interposed between two protective layers.

According to the aforementioned configuration, by interposing the infrared light partially transmissive portion between the two protective layers, the infrared light partially transmissive portion can be protected from dirt and damage.

In the liquid crystal display device of the present invention, the total thickness of the infrared light partially transmissive portion and the two protective layers may be 30 μm or more and 200 μm or less.

According to the aforementioned configuration, by making the total thickness of the aforementioned three layers 200 μm or less, the thickness of the overall liquid crystal display device can be maintained relatively thin. Moreover, by making the total thickness of the aforementioned three layers 30 μm or more, in-plane unevenness caused by contraction due to heat can be suppressed.

Between the aforementioned liquid crystal panel and the aforementioned infrared light partially transmissive portion, a polarizing plate and an adhesive layer may be disposed to be layered in this order from the liquid crystal panel side, and the adhesive layer may be subjected to a diffusion treatment.

According to the aforementioned configuration, the adhesive layer is disposed between the aforementioned infrared light partially transmissive portion and the polarizing plate, and the adhesive layer has been processed by the diffusion treatment. This way, the boundaries between the infrared light transmissive regions and the non-transmissive region in the infrared light partially transmissive portion can be made less visible (difficult to be recognized visually).

As a specific example of the aforementioned diffusion treatment, a treatment of including fine particles (diffusers) such as Si (silica) or the like that have a different refractive index from the base material in the aforementioned adhesive layer to give the adhesive layer a diffusing function and the like can be suggested.

The present invention is not limited to the aforementioned embodiments, and various modifications are possible within the scope shown in claims. Embodiments obtained by appropriately combining technical means disclosed here are included in the technical scope of the present invention.

### INDUSTRIAL APPLICABILITY

The present invention can be applied to an area sensor integrated liquid crystal display device equipped with an area sensor (specifically, a touch panel).

### DESCRIPTION OF REFERENCE CHARACTERS

10 backlight

20 liquid crystal panel

21 active matrix substrate

22 opposite substrate

23 liquid crystal layer

24 color filter layer

24a visible light cut filter

30 optical sensor element

40a front side polarizing plate

40b back side polarizing plate

50 infrared light transmissive sheet (infrared light partially transmissive portion)

50a infrared light transmissive region

50b infrared light blocking region (non-transmissive region)

51 infrared light partially transmissive layer (infrared light partially transmissive portion)

52a protective layer

52b protective layer

53 adhesive layer

100 liquid crystal display device (touch panel integrated liquid crystal display device)

100a detection object surface (device surface)

As shown in FIG. 5(b), suppose that the intensity of signal light during a touched state is 1.0 in the conventional liquid crystal display device. Then, as shown in FIG. 5(a), the intensity of signal light during a touched state is 0.8 in the liquid crystal display device 100. Moreover, as shown in FIG. 5(b), the intensity of signal light during an untouched state becomes 0.9 in the conventional liquid crystal display device. In contrast, the intensity of signal light during an untouched state in the liquid crystal display device 100 becomes 0.9×0.8×0.8=0.58 (see FIG. 5(a)) because it is transmitted through the infrared light transmissive sheet 50 twice. This way, in the liquid crystal display device 100, the intensity itself of signal light during a touched state is lower than that of the conventional liquid crystal display device. However, the difference in signals between a touched state and an untouched state becomes larger.

According to the aforementioned configuration, by making the dimension of the aforementioned region 5 μm or more, a sufficient sensor output for detecting an input position can be obtained. Moreover, by making the dimension of the aforementioned region 30 μm or less, the boundaries between the infrared light transmissive regions and the non-transmissive region becoming visible can be prevented.

1. A liquid crystal display device, comprising:
a liquid crystal panel in which a liquid crystal layer is disposed between an active matrix substrate and an opposite substrate; and
a backlight that irradiates said liquid crystal panel with light,
wherein said liquid crystal panel includes a plurality of optical sensor elements that detect an intensity of received infrared light,
wherein said backlight has a light source that emits infrared light,
wherein an infrared light partially transmissive portion that partially transmits infrared light is provided on an image display surface side of said liquid crystal panel, and
wherein said optical sensor elements detect an input position from outside by detecting infrared light reflected from an inputting object on a surface of the device.

2. The liquid crystal display device according to claim 1, wherein said infrared light partially transmissive portion includes a non-transmissive region that does not transmit infrared light and a plurality of infrared light transmissive regions that are arranged regularly with respect to said non-transmissive region.

3. The liquid crystal display device according to claim 2, wherein a dimension of said respective infrared light transmissive regions is 5 μm or more and 30 μm or less.

4. The liquid crystal display device according to claim 2, wherein said respective infrared light transmissive regions have a same shape.

5. The liquid crystal display device according to claim 4, wherein said respective infrared light transmissive regions have a circular shape.

6. The liquid crystal display device according to claim 2, wherein an interval between the respective infrared light transmissive regions adjacent to each other is 10 μm or more and 200 μm or less.

7. The liquid crystal display device according to claim 2, wherein said non-transmissive region is formed of a band-pass filter that blocks light in an infrared region, and
wherein said infrared light transmissive region is formed of a cavity.

8. The liquid crystal display device according to claim 1, wherein said infrared light partially transmissive portion is disposed so as to be interposed between two protective layers.

9. The liquid crystal display device according to claim 8, wherein a total thickness of said infrared light partially transmissive portion and said two protective layers is 30 μm or more and 200 μm or less.

10. The liquid crystal display device according to claim 1, wherein between said liquid crystal panel and said infrared light partially transmissive portion, a polarizing plate and an adhesive layer are disposed to be layered in this order from said liquid crystal panel side, and
wherein said adhesive layer has been processed by a diffusion treatment.
